(19) United States
(12) Patent Application Publication
(10) Pub. No.: US 2003/0032714 A1
(43) Pub. Date: Feb. 13, 2003

(54) Rubber composition for roller and recording medium feeding roller using the same

(76) Inventor: Hiroshi Kawasaki, Tokyo (JP)

Correspondence Address: Fox, Rothschild, O'Brien & Frankel LLP, 10th Floor, 2000 Market Street, Philadelphia, PA, 19103, US

(21) Appl. No.: 10/167,980

(22) Filed: Jun. 10, 2002

Related U.S. Application Data
(63) Continuation of application No. 08/862,271, filed on May 23, 1997, now abandoned.

(30) Foreign Application Priority Data
May 27, 1996 (JP) 131887/1996

(51) Int. Cl. C08L 55/00; C08L 23/18

(52) U.S. Cl. 524/554; 524/579

(57) ABSTRACT

A rubber composition for a roller is disclosed, which comprises: 100 parts by weight of an ethylene/propylene/non-conjugated diene terpolymer, 125 to 180 parts by weight of a softener, and 15 to 40 parts by weight of a silica reinforcer. A recording medium feeding roller is also disclosed, at least whose surface portion is made of the rubber composition for a roller. By virtue of these features, the rubber composition for a roller and the recording medium feeding roller is capable of reliably preventing migratory stain from depositing on a surface of recording medium when brought into contact with the recording medium.

### BACKGROUND OF THE INVENTION

1. Field of the Invention

The present invetnion relates to a rubber composition for a roller and a recording medium feeding roller using the same. More particularly, it relates to a rubber composition for a roller, which is suitably used for a feeding roller, for example, a feed roller and a paper feed roller such as a pickup roller or a separatory roller, that is used for advancing a recording medium in a xerographic copying machine or a laser beam printer, and a recording medium feeding roller using the same.

2. Description of the Prior Art

Heretofore, in a xerographic copying machine, a laser beam printer (hereinafter referred to as LBP) or the like, recording medium feeding rollers at least whose surface portions are made of a rubber layer have been used for advancing a recording medium such as a plain paper, an OHP paper or a postcard.

For such a rubber layer of a roller for feeding of a recording medium a polynorbornene rubber composition having a hardness of about 25 point (as measured by Shore A durometer) is frequently used because it is capable of reliably attaining a sufficient touch area and providing a high coefficient of dynamic friction when it is brought into contact with a recording medium to enable stable feeding of a recording medium.

However, such a polynorbornene rubber composition has problems that it is poor in weather resistance and ozone resistance, and that it undergoes considerable abrasion during feeding of about 100 thousands sheets of recording medium and hence cannot maintain stable feed properties for a long period of time.

To cope with these problems, rubber compositions containing an ethylene/propylene/diene terpolymer (EPDM) as a main component which provide improved weather resistance and abrasion resistance have been proposed in Japanese Patent Laid-open Publication Nos. 70636/1990 and 41324/1994, etc.

However, a recording medium feeding roller whose surface rubber layer is made of the conventional EPDM-based rubber composition disclosed in Japanese Patent Laid-open Publication No. 4 1324/1994, in particular, the conventional EPDM-based rubber composition using a carbon black as a reinforcer has a problem that although the roller exhibits improved weather resistance and abrasion resistance, the carbon black as a reinforcer tends to be released from the surface of the rubber layer of the recording medium feeding roller to cause deposition of black migratory stain on a surface of a recording medium, i.e., so-called crocking when the rubber layer is brought into contact with the recording medium.

On the other hand, a recording medium feeding roller whose surface rubber layer is made of the conventional EPDM-based rubber composition using no carbon black as a reinforcer which is disclosed in Japanese Patent Laid-open Publication No. 70636/1990 has a problem that white migratory stain, which is released from the surface of the rubber layer of the recording medium feeding roller, tends to deposit on a surface of a recording medium although the roller exhibits improved weather resistance and abrasion resistance.

In other words, each of the recording medium feeding rollers using the conventional EPDM-based rubber compositions as rubber compositions for a roller has a problem that migration, i.e., deposition of black or white migratory stain on the surface of the recording medium tends to be caused when the rubber layer is brought into contact with the recording medium, although the roller exhibits improved weather resistance and abrasion resistance.

Under the circumstances, it has been desired to attain a rubber composition for a roller and a recording medium feeding roller using the same which are capable of surely preventing migratory stain from depositing on a surface of a recording medium when the roller is brought into contact with the recording medium.

### SUMMARY OF THE INVENTION

It is, therefore, an object of the present invention to provide a rubber composition for a roller and a recording medium feeding roller using the same which are capable of surely preventing migratory stain from depositing on a surface of a recording medium when the roller is brought into contact with the recording medium.

To achieve the above objective, the present inventors have made intensive and extensive studies with a view to obtaining a rubber composition for a roller and a recording medium feeding roller using the same which are free from deposition of migratory stain on a variety of recording media, i.e., free from so-called migration, and as a result, they have found that incorporation of a softener and a silica reinforcer, in combination, into an ethylene/propylene-copolynmerized rubber (EPDM) enables an elastomer to be provided which is free from so-called migration and which has excellent mechanical strengths and a high friction coefficient. The present invention has been completed on the basis of the finding.

According to one aspect of the present invention, there is provided a rubber composition for a roller, said rubber composition comprising:

100 parts by weight of an ethylene/propylene/non-conjugated diene terpolymer,

125 to 180 parts by weight of a softener, and

15 to 40 parts by weight of a silica reinforcer.

It is preferred to use a hydrous silica or anhydrous silica as the silica reinforcer.

According to another aspect of the present invention, there is provided a recording medium feeding roller, at least whose surface portion is made of the rubber composition for a roller which composition comprises:

100 parts by weight of an ethylene/propylene/non-conjugated diene terpolymer,

125 to 180 parts by weight of a softener, and

15 to 40 parts by weight of a silica reinforcer.

By virtue of the incorporation of the softener and silica reinfoecer in the ethylene/propylene/non-conjugated diene terpolymer, the rubber compsition for a roller according to the present invention is capable of providing a high coefficient of dynamic friction and excellent mechanical strenghts, and of attaining markedly improved anti-migration effect by which deposition of migratory stain on a recording medium is reliably prevented.

The the rubber composition for a roller of the present invention and the recording medium feeding roller using the same enable extremely excellent effect to be realized in that the recording medium feeding roller has a high coefficient of dynamic friction and satisfactory feed properties and is capable of surely preventing migratory stain from depositing onto the surface of recording medium when brought into contact with the recording medium.

### BRIEF DESCRIPTION OF THE DRAWINGS

FIGS. 1(a) to 1(c) show an embodiment of the recording medium feeding roller using the rubber composition for a roller according to the present invention, wherein FIG. 1(a) is a vertical sectional view, FIG. 1(b) is a vertical sectional view showing a rubber ring, and FIG. 1(c) is a vertical sectional view showing a holder.

FIG. 2 is an illustrative view schematically showing a friction coefficient measuring system for determining a coefficient of dynamic friction of the recording medium feeding roller using the rubber composition for a roller according to the present invenion.

### DETAILED DESCRIPTION OF THE INVENTION

Examples of the present invention will be described hereinbelow.

The ethylene/propylene-copolymerized rubber used as a base rubber material of the rubber composition for a roller according to the present invention means an ethylene/propylene/non-conjugated diene terpolymer (EPDM) which is a non-conjugated diene-incorporated ethylene/propylene copolymer. The non-conjugated diene is incorporated as a third component having an unsaturated bond. As the third component, there may be mentioned dicyclopentadiene, dicyclooctadiene, 5-methylene-2-norbornene, 5-ethylidene-2-norbornene, and 1,4-hexadiene. Specific examples of the EPDM include Mitsui-EPT 0045, 1035, 1045, 1060, 1070, 1071, 3 012P, 3045, 3042E, 3062E, 3070, 3072E, 3090E, 8075E, 3091, 3095, 4010, 4021, 4045, 4070 and 4095 (tradenames, manufactured by Mitsui Petrochemical Industries, Ltd. Japan); ESPRENE 201, 301, 3 05, 400, 501A, 502, 505, 505A, 512F, 514F, 522, 524, 532, 552, 5 53, 567, 582F, 586, 600F, 601F, 606, 670F, 671F, 673, 5754, 6505 S and 6182F (tradenames, manufactured by Sumitomo Chemical Co., Ltd., Japan); JSREP912P, EP01P, EP02P, EP941P, EP961SP, EP07P, EP57P, EP181SP, EP11, EP43, EP93, EP24, EP27, EP21, EP132, EP22, EP25, EP33, EP35, EP37C/F, EP65, EP51, EP57C/F, EP75F, EP86, EP96, EP 98, EP103AF, EP106EF, EP107F, EP801E and EP001DE (tradenames, manufactured by Japan Synthetic Rubber Co., Ltd., Japan); KELTAN 520, 720, 820, 312, 512, 712, 812, 314, 541, 714, 378, 578, 778, 450 2, 4802, 4778, 4703, 4903, 5631A, 512x50, 708x15 and 509x100 (tradenames, manufactured by DSM IDEMITSU Co., Ltd.); NORDEL 1040, 1070, 1145, 1320, 1440, 1470, 1660, 2522, 2722/P, 2744/P and 276 0/P (tradenames, manufactured by DuPont, U.S.A.); EPSYN 40-A, 70-A, 55, 2308, 2506, 4506, 4906, 5206, 5508, 5805, 7506, E801, N557, N597, N997, P557, P558, P597, MDE239 and MDE 248 (tradenames, Copolymer Rubber & Chemical Corp., U.S.A.); and POLYSAR 227, 306, 3 45, 585, 487XP, 865, 965, 5465, 5672X, 5875 and 6463 (tradenames, manufactured by Polysar Rubber Corp., U.S.A).

In the present invention, these EPDMs may be used alone or, for the purpose of adjustment of Mooney viscosity, propylene content, oil extended content, cure speed or the like, in combination as a blend of two or more EPDMs or in combination with another type of rubber such as an SBR.

Further, in the present invention, a softner is incorporated into 100 parts by weight of the base rubber material in an amount of 125 to 180 parts by weight to form a heavily loaded mix Accordingly, it is preferred in terms of processability to use an EPDM grade preliminarily extended with an oil such as a naphthenic oil, paraffinic oil or the like. Specific examples of the oil-extended grade are as follows. As naphthenic oil-extended grades, there may be mentioned ESPRENE 400, 600F, 601F and 606 (tradenames, manufactured by Sumitomo Chemical Co., Ltd., Japan); EPSYN N557, N597 and N997 (tradenames, manufactured by Copolymer Rubber & Chemical Corp., U.S.A.); and POLYSAR 5465 and 5875 (tradenames, manufactured by Polysar Rubber Corp.).

As paraffinic oil-extended grades, there may be mentioned Mitsui-EPT 3042E, 3062E, 3072E, 3090E and 8075E (tradenames, manufactured by Mitsui Petrochemical Industries, Ltd.); JSR EP96, EP98, EP106EF, EP801E and EP001DE (tradenames, manufactured by Japan Synthetic Rubber Co., Ltd., Japan); KELTAN 512X50, 708X15 and 509X100 (tradenames, manufactured by DSM IDEMITSU Co., Ltd.); EPSYN P557, P558, P597, MDE239 and MDE248 (tradenames, manufactured by Copolymer Rubber & Chemical Corp., U.S.A.); and POLYSAR 5465, 5672X5875 and 6463 (tradenames, manufactured by Polysar Rubber Corp., U. S.A.).

As aromatic oil-extended grades, ESPRENE E670F and E671F (tradenames, manufactured by Sumitomo Chemical Co., Ltd., Japan) may be mentioned.

In the cure (crosslinking) of the rubber composition for a roller according to the present invention, a customary cure system such as a sulfur cure system or a peroxide cure system may be used.

There is no particular restriction with respect to the peroxide used in the peroxide cure. Those used in customary organic peroxide cure may be used. Examples of the peroxide are as follows.

As peroxy ketals, there may be mentioned 1,1-bis(tert-butyl peroxy)-3,3,5-trimethyl cyclohexane such as PERHEXA 3M (tradename, manufactured by Nippon Oil & Fats Co., Ltd., Japan, 90% product), PERHEXA 3M-40 (tradename, manufactured by Nippon Oil & Fats Co., Ltd., Japan, 40% product), Trigonox 29A (tradename, manufactured by Akzo Chemicals Inc., 90% product), Trigonox 29-40 (tradename, manufactured by Akzo Chemicals Inc., 40% product), Sanperox CY-11 (tradename, manufactured by Sanken Chemical Co., Ltd., 95% product), Luperco 231XL (tradename, manufactured by Harwick Chemical Corp., 40% product), and Varox 231 XL (tradename, manufactured by R. T. Vanderbilt, U.S.A., 40% product); 1,1-bis (tert-butyl peroxy) cyclohexane such as PERHEXA C (tradename, manufactured by Nippon Oil & Fats Co., Ltd., Japan, 70% product); 2,2-bis(tert-butyl peroxy)octane such as PERHEXA O (tradename, manufactured by Nippon Oil & Fats Co., Ltd., Japan, 70% product), and PERHEXA O-40 (tradename, manufactured by Nippon Oil & Fats Co., Ltd., Japan, 40% product); n-butyl-4,4-bis(tert-butyl peroxy)valerate such as PERHEXA V (tradename, manufactured by Nippon Oil & Fats Co., Ltd., Japan, 90% product), PERHEXA V-40 (tradename, manufactured by Nippon Oil & Fats Co., Ltd., Japan, 40% product), and Trigonox 17-40 (tradename, manufactured by Akzo Chemicals Inc., 40% product); and 1,1-bis-(tert-butyl peroxy)cyclododecane such as PERHEXA CD (tradename, manufactured by Nippon Oil & Fats Co., Ltd., Japan, 98% product).

As dialkyl peroxides, there may be mentioned di-tert-butyl peroxide such as PERBUTYL D (tradename, manufactured by Nippon Oil & Fats Co., Ltd., Japan, 97% product), KAYABUTYL D (tradename, manufactured by Akzo Chemicals Inc., 97% product), and Sanperox DT (tradename, manufactured by Sanken Chemical Co., Ltd., Japan, 98% product); t-butyl cumyl peroxide such as PERBUTYL C (tradename, manufactured by Nippon Oil & Fats Co., Ltd., Japan, 90% product), KAYABUTYL C (tradename, manufactured by Akzo Chemicals Inc., 90% product), and Sanperox CT (tradename, manufactured by Sanken Chemical Co., Ltd., Japan, 90% product); dicmyl peroxide such as PERCUMYL D (tradename, manufactured by Nippon Oil & Fats Co., Ltd., Japan, 99% product), PERCUMYL D-40 (tradename, manufactured by Nippon Oil & Fats Co., Ltd., Japan, 40% product), KAYACMYL D (tradename, manufactured by Akzo Chemicals Inc., 97% product), KAYACMYL D-40 (tradename, manufactured by Akzo Chemicals Inc., 40% product), Mitsui DCP (tradename, manufactured by Mitsui Petrochemical Industries, Ltd., Japan, 98% product), Sanperox DCP-98 (tradename, manufactured by Sanken Chemical Co., Ltd., Japan, 98% product), Luperox 500-40C (tradename, manufactured by Lucidol Yoshitomi, Ltd., Japan, 40% product), Di-Cup 40KE (tradename, manufactured by Hercules Inc., U.S.A., 40% product), and Varox DCP-40C (tradename, manufactured by R. T. Vanderbilt, U.S. A., 40% product); α,α′-bis (tert-butyl peroxy-m-isopropyl) benzene such as PERBUTYL P (tradename, manufactured by Nippon Oil & Fats Co., Ltd., Japan, 95% product), Peroximon F-40 (tradename, manufactured by Nippon Oil & Fats Co., Ltd., Japan, 40% product), Perkadox 14 (tradename, manufactured by Akzo Chemicals Inc., 96% product), Perkadox 14-40 (tradename, manufactured by Akzo Chemicals Inc., 40% product), Sanperox TY-13 (tradename, manufactured by Sanken Chemical Co., Ltd., Japan, 98% product), Luperco 802XL (tradename, manufactured by Harwick Chemical Corp., 4 0% product), Vul-cup 40KE (tradename, manufactured by Hercules Inc., U.S.A., 40% product), and Varox VC-40KE (tradename, manufactured by R. T. Vanderbilt, U.S.A., 40% product); 2,5-dimethyl-2,5-di(tert-butyl peroxy)hexane such as PERHEXA 25B (tradename, manufactured by Nippon Oil & Fats Co., Ltd., Japan, 90% product), PERHEXA 25B-40 (tradename, manufactured by Nippon Oil & Fats Co., Ltd., Japan, 40% product), KAYAHEXA AD (tradename, manufactured by Akzo Chemicals Inc., 90% product), KAYAHEXA AD-40 (tradename, manufactured by Akzo Chemicals Inc., 40% product), Luperco 101XL (tradename, manufactured by Harwick Chemical Corp., 45% product), and Varox DBPH-50 (tradename, manufactured by R. T. Vanderbilt, U.S. A., 45% product); and 2,5-dimethyl-2,5-di(tert-butyl peroxy)hexane-3 such as PERHEXINE 25B (tradename, manufactured by Nippon Oil & Fats Co., Ltd., Japan, 90% product), PERHEXINE 25B-40 (tradename, manufactured by Nippon Oil & Fats Co., Ltd., Japan, 4.0% product), KAYAHEXA YD (tradename, manufactured by Akzo Chemicals Inc., 90% product), KAYAHEXA YD-50 (manufactured by Akzo Chemicals Inc., 50% product), Sunperox YPO (tradename, manufactured by Sanken Chemical Co., Ltd., Japan, 90% product), and Luperco 130 XL (tradename, manufactured by Harwick Chemical Corp., 45% product).

As alkyl peresters, there may be mentioned tert-butyl peroxy-2-ethyl hexanoate such as PERBUTYL O (tradename, manufactured by Nippon Oil & Fats Co., Ltd., Japan, 97% product), KAYAESTER O (tradename, manufactured by Akzo Chemicals Inc., 97% product), Sanperox TO (tradename, manufactured by Sanken Chemical Co., Ltd., Japan, 97% product), and Lupasol PDO (tradename, manufactured by Lucidol Yoshitomi, Ltd., 97% product); tert-butyl peroxy-3,5,5-trimethyl hexanoate such as PERBUTYL 355 (tradename, manufactured by Nippon Oil & Fats Co., Ltd., Japan, 97% product), and Trigonox 42 (tradename, manufactured by Akzo Chemicals Inc., 9 4% product); 2,5-dimethyl-2,5-di(benzoyl peroxy)hexane such as PERHEXA 25Z (tradename, manufactured by Nippon Oil & Fats Co., Ltd., Japan, 90% product), Sanperox APB (tradename, manufactured by Sanken Chemical Co., Ltd., Japan, 90% product), and Luperox 118 (tradename, manufactured by Lucidol Yoshitomi, Ltd., 90% product); and tert-butyl peroxy isopropyl carbonate such as PERBUTYL I (tradename, manufactured by Nippon Oil & Fats Co., Ltd., Japan, 95% product), KAYACARBON BIC-75 (tradename, manufactured by Akzo Chemicals Inc., 75% product), and Lupasol TBIC-M75 (tradename, manufactured by Lucidol Yoshitomi, Ltd., 75% product).

With a view to improving dispersion in the base polymer and to preventing scattering, an EPT-based peroxide masterbatch or the like may be used. As such masterbatches, there may be mentioned Trigonox 29-40 MB G R [tradename, manufactured by Akzo Chemicals Inc., 40% product of 1,1-bis(tert-butyl peroxy)3,5,5-trimethyl cyclohexane], Trigonox 17-40% G R [tradename, manufactured by Akzo Chemicals Inc., 40% product of n-butyl-4,4-bis(tert-butyl peroxy) valerate], PERKADOX BC-40 MB G R [tradename, manufactured by Akzo Chemicals Inc., 40% product of dicmyl peroxide], PERKADOX 14-4 0MB G R [tradename, manufactured by Akzo Chemicals Inc., 40% product of α,α′-bis (tert-butyl peroxy-m-isopropyl)benzene], and Trigonox 101-40MD G R [tradename, manufactured by Akzo Chemicals Inc., 40% product of 2,5-dimethyl-2,5-di(tert-butyl peroxy)hexane].

In this connection, α,α′-bis(tert-butyl peroxy-m-isopropyl)benzene can cause blooming when used as the cure agent (crosslinking agent). Accordingly, it is preferred to use α,α′-bis (tert-butyl peroxy-m-isopropyl)benzene in combination with 0. 5 to 1 part by weight of a polyethylene glycol such as PEG 4000S (tradename, manufactured by Sanyo Chemical Industries, Ltd., Japan).

In peroxide cure, with a view to improving physical properties and cure speed, an appropriate co-crosslinking agent may be used in an amount of 0.5 to 5 parts by weight according to need. Examples of the co-crosslinking agent include sulfur (S) such as “Golden Flower” sulfur powders of 150 mesh, 200 mesh, 300 mesh and 325 mesh (tradename, manufactured by Tsurumi Chemical Industry, Co., Ltd., Japan), SULFAX A, 200S, MC, PS and PMC (tradename, manufactured by Tsurumi Chemical Industry, Co., Ltd., Japan), Seimi Sulfur (tradename, manufactured by Nippon Kanryu Industry Co., Ltd., Japan), and Sanfel and Sanfel 90 (tradename, manufactured by Sanshin Chemical Industry Co., Ltd., Japan); glycidyl methacrylate (GMA) such as Blemmer G (tradename, manufactured by Nippon Oil & Fats Co., Ltd., Japan); maleic anhydride (MA) such as Crystalman (tradename, manufactured by Nippon Oil & Fats Co., Ltd., Japan); zinc oxide (ZnO) such as Zinc Oxide No. 1 (tradename, manufactured by Sakai Chemical Industry Co., Ltd., Japan); N,N′-m-phenylene bismaleimide such as Actor PBM-R (tradename, manufactured by Kawaguchi Chemical Industry Co., Ltd., Japan); p-quinone dioxime (GM) such as Actor Q (tradename, manufactured by Kawaguchi Chemical Industry Co., Ltd., Japan); p,p′-dibenzoylbenzoquinone dioxime (DGM) such as Actor DQ (tradename, manufactured by Kawaguchi Chemical Industry Co., Ltd., Japan); 2-mercaptobenzothiazole (MBT) such as Accel M (tradename, manufactured by Kawaguchi Chemical Industry Co., Ltd., Japan); 2-benzothiazolyl disulfide (MBTS) such as Accel DM (tradename, manufactured by Kawaguchi Chemical Industry Co., Ltd., Japan); tetramethylthiuram disulfide (TMTD) such as Accel TMT (tradename, manufactured by Kawaguchi Chemical Industry Co., Ltd. Japan); N-oxydiethylene-2-benzothiazole sulfenamide (OBS) such as Accel NS (tradename, manufactured by Kawaguchi Chemical Industry Co., Ltd., Japan); N-cyclohexyl-benzothiazole sulfenamide (CBS) such as Accel CZ (tradename, manufactured by Kawaguchi Chemical Industry Co., Ltd., Japan) 1,2-polybutadiene (1,2-PB) such as Nisso PB (tradename, manufactured by Nippon Soda Co., Ltd., Japan); polyethylene glycol dimethacrylate (PEGDM) such as Blemmer PDE-100 (tradename, manufactured by Nippon Oil & Fats Co., Ltd., Japan); diallyl phthalate (DAP); triallyl isocyanurate (TAIC) such as TAIC (tradename, manufactured by Nippon Kasei Chemical Co., Ltd., Japan); triallyl cyanurate (TAC) such as TAC (tradename, manufactured by Musashino Kagaku Kenkyusho, Japan); tetrahydrofurfuryl methacrylate (THFMA) such as Acryester THF (tradename, manufactured by Mitsubishi Rayon Co., Ltd., Japan); ethylene dimethacrylate (EDMA) such as Sanester EG (tradename, manufactured by Sanshin Chemical Ind. Co., Ltd., Japan) and Acryester ED (tradename, manufactured by Mitsubishi Rayon Co., Ltd.); 1,3-butylene dimethacrylate (BDMA) such as Acryester BD (tradename, manufactured by Mitsubishi Rayon Co., Ltd., Japan); and trimethylolpropane trimethacrylate (TMPMA) such as Sanester TMPMA (tradename, manufactured by Sanshin Chemical Ind. Co., Ltd., Japan), Acryester TMP (tradename, manufactured by Mitsubishi Rayon Co., Ltd., Japan), and Hi-Cross M (tradename, manufactured by Seiko Chemical Co., Ltd., Japan).

The sulfur used in the sulfur cure is added to the base rubber material in an amount of about 0 to 5 parts by weight relative to 100 parts by weight of the base rubber material. As the sulfer, a fine sulfur powder may be used which is obtained by pulverizing a recovered sulfur into a fine powder. Examples of the fine sulfur powder include “Golden Flower” sulfur powders of 150 mesh, 200 mesh, 300 mesh and 325 mesh (tradename, manufactured by Tsurumi Chemical industry Co., Ltd., Japan). Further, a surface-treated sulfur having improved dispersibility may appropriately be used. Examples of the surface-treated sulfur include SULFAX A 200S, MC, PS and PMC (tradenames, manufactured by Tsurumi Chemical Industry Co., Ltd., Japan). To prevent blooming derived from an uncured rubber, an insoluble sulfur is used. Examples of the insoluble sulfur include Seimi Sulfur (tradename, manufactured by Nippon Kanryu Industry Co., Ltd., Japan), and Sunfel and Sunfel 90 (tradenames, manufactured by Sanshin Chemical Ind. Co., Ltd., Japan).

When particularly low compression set is required, no sulfur per se is used. Instead of sulfur, a sulfur-containing organic compound is used as a vulcanizing agent (cross-linking agent). As the sulfur-containing organic compound, there may be mentioned 4,4′-dithiodimorpholine such as Actor R (tradename, manufactured by Kawaguchi Chemical Industry Co., Ltd., Japan); manufactured by Kawaguchi Chemical Industry Co., Ltd., Japan); tetraethylthiuram disulfide such as Accel TET (tradename, manufactured by Kawaguchi Chemical Industry Co., Ltd., Japan); and dipentamethylenethiuram tetrasulfide such as Accel TRA (tradename, manufactured by Kawaguchi Chemical Industry Co., Ltd., Japan). The sulfur-containing organic compound is added in an amount of about 0. 5 to 5 parts by weight relative to 100 parts by weight of the base rubber material.

In sulfur cure, to attain improved physical properties of a vulcanizate, in particlular, low compression set and processing stability, 1 to 6 of vulcanization accelerators are generally added each in an amount of 0.5 to 3 parts by weight relative to 100 parts by weight of the base rubber material. Examples of the vulcanizing accelerator include thialzoles, thioureas, thiurams, dithiocarbamates and guanidines. As the thiazoles, there may be mentioned 2-mercaptobenzothiazole such as Accel M (tradename, manufactured by Kawaguchi Chemical Industry Co., Ltd., Japan); 2-benzothiazolyl disulfide such as Accel DM (tradename, manufactured by Kawaguchi Chemical Industry Co., Ltd., Japan); N-cyclohexyl-2-benzothiazole sulfenamide such as Accel CZ (tradename, manufactured by Kawaguchi Chemical Industry Co., Ltd., Japan); N-oxydiethylene-2-benzothiazole sulfenamide such as Accel NS (tradename, manufactured by Kawaguchi Chemical Industry Co., Ltd., Japan); N-t-butyl-2-benzothiazole sulfenamide such as Accel BNS-R (tradename, manufactured by Kawaguchi Chemical Industry Co., Ltd.); and N,N-dicyclohexyl-2-benzothiazole sulfenamide such as Accel DZ-G (tradename, manufactured by Kawaguchi Chemical Industry Co., Ltd.). As the thioureas, diethyl thiourea such as Accel EUR (tradename, manufactured by Kawaguchi Chemical Industry Co., Ltd.); and ethylenethiourea such as Accel 22-S (tradename, manufactured by Kawaguchi Chemical Industry Co., Ltd.) may be mentioned. As the thiurams, there may be mentioned tetramethylthiuram disulfide such as Accel TMT (tradename, manufactured by Kawaguchi Chemical Industry Co., Ltd.); tetraethylthiuram disulfide such as Accel TET (tradename, manufactured by Kawaguchi Chemical Industry Co., Ltd.) tetrabutylthiuram disulfide such as Accel TBT (tradename, manufactured by Kawaguchi Chemical Industry Co., Ltd.); dipentamethylenethiuram tetrasulfide such as Accel TRA (tradename, manufactured by Kawaguchi Chemical Industry Co., Ltd.); and tetramethylthiuram monosulfide such as Accel TS (tradename, manufactured by Kawaguchi Chemical Industry Co., Ltd.). As the dithiocarbamates, there may be mentioned zinc dimethyldithiocarbamate such as Accel PZ (tradename, manufactured by Kawaguchi Chemical Industry Co., Ltd.); zinc diethyldithiocarbamate such as Accel EZ (tradename, manufactured by Kawaguchi Chemical Industry Co., Ltd.); zinc dibutyldithiocarbamate such as Accel BZ (tradename, manufactured by Kawaguchi Chemical Industry Co., Ltd.) and tellurium diethyldithiocarbamate such as Accel TL-PT (tradename, manufactured by Kawaguchi Chemical Industry Co., Ltd.). As the guanidines, diphenyl guanidine such as Accel D (tradename, manufactured by Kawaguchi Chemical Industry Co., Ltd.) may be mentioned.

In the rubber composition for a roller according to the present invention, a softener is added in an amount as high as 125 to 180 parts by weight relative to 100 parts by weight of the ethylene/propylene-copolymerized rubber as a base rubber material to obtain a composition having a low hardness, to enable ingredients to be mixed and dispersed well, to facilitate forming operation such as sheeting or extrusion, and to increase tackiness of unvulcanized rubber for easy forming. If the amount of the softener is less than 125 parts by weight, a composition having a low hardness cannot be obtained. On the other hand, if the softener is used in an amount more than 180 parts by weight, processability is poor. The softener should be selected taking its compatibility with the ethylene/propylene-copolymerized rubber into consideration. In this regard, it is preferred to use a paraffinic oil, a naphthenic oil or an aromatic oil.

When a preliminarily oil-extended grade is used as described above, the softener is separately added in an amount of a predetermined total amount less the softener content (parts by weight) of the preliminarily oil-extended grade. For example, since Esprene 600F (tradename, manufactured by Sumitomo Chemical Co., Ltd.) comprises a base rubber material which has preliminarily been oil-extended with 100 parts by weight of a naphthenic oil relative to 100 parts by weight of the base rubber material, when a tolal amount of the softener of 130 parts by weight is intended the balance of 30 parts by weight of the softener is separately added relative to 200 parts by weight of Esprene 600F (100 parts by weight of the base rubber material+100 parts by weight of the softener).

Commercially available examples of the paraffinic oil softener include Diana Process Oil PW-32, PW-90, PW-150, PW-380, PS-32, PS-90, PS-430, PX-32 and PX-90 (tradenames, manufactured by Idemitsu Kosan Co., Ltd., Japan); Flexon 845 (tradename, manufactured by Exxon Company, U.S.A.); SHINTAC PA-95, PA-100 and PA-140 (tradenames, manufactured by Kobe Oil Chemical Ind. Co., Ltd., Japan); COSMO PROCESS 10, 40 and 40C (tradenames, manufactured by Cosmo Oil Co., Ltd.); SUNPER 110, 115, 120, 130, 150, 180, 2100, 2 210 and 2280 (tradenames, manufactured by Sun Oil Company); FUKKOL P-200, P-400 and P-500 (tradenames, manufactured by Fuji Kosan Co., Ltd., Japan); and Mitsubishi 10 and Mitshubishi 20 (tradenames, manufactured by Mitsubishi Oil Co., Ltd., Japan).

Commercially available examples of the naphthenic oil softener include Diana Process Oil NS-24, NS-100, NM-26, NM-68, NM-150, NM-280, NP-24, NU-80 and NF-90 (tradenames, manufactured by Idemitsu Kosan Co., Ltd.); FLEXON 580, 641, 650, 660, 680, 765, 766 and 785 (tradenames, manufactured by Exxon Company, U.S.A); SHINTAC N-40, N-60, N-70, N-75 and N-85 (tradenames, manufactured by Kobe Oil Chemical Ind. Co., Ltd.); SHELLFLEX 371JY, 371N, 451, N-40, 22, 22R, 32R, 100R, 100S, 100SA, 200RS, 200S, 2 60, 320R and 680 (tradenames, manufactured by Shell Japan Ltd.); SUNTHENE 310, 380, 410, 415, 420, 430, 450, 480, 3215, 4130 and 4240, and Ciro Light R.P.O. (tradenames, manufactured by Sun Oil Company); Komolex No. 2 (tradename, manufactured by Nippon Oil Co., Ltd.); FUKKOL 1150N and 1400N (tradenames, manufactured by Fuji Kosan Co., Ltd.); Mitsubishi 20 (tradename, manufactured by Mitsubishi Oil Co., Ltd.); NAPHLEX 32 and 38 (tradenames, manufactured by Mobil Oil Co., Ltd.); and Petolex PN-3 (tradename, manufactured by Yamabun Yuka Co., Ltd., Japan).

Commercially available examples of the aromatic oil softener include Diana Process Oil AC-12, AC-460, AE-24, AE-50, AE-200, AH-16 and AH-58 (tradenames, manufactured by Idemitsu Kosan Co., Ltd.); FLEXON 340 and FLEXXON 391 (manufactured by Esxon Company, U.S.A.) SHINTAC HA-10, HA-15, HA-30 and HA-35 (tradenames, manufactured by Kobe Oil Chemical Ind. Co., Ltd.); Cosmo Process 40A (tradename, manufactured by Cosmo Oil Co., Ltd.); Sundex 790 (tradename, manufactured by Sun Oil Company); KOMOLEX 30 0 and 700 (tradenames, manufactured by Nippon Oil Co., Ltd.); AROMAX #1, #3 and #5 (tradenames, manufactured by Fuji Kosan Co., Ltd.); Heavy Process Oils Mitsubishi 34, Mitsubishi 38 and Mitsubishi 44 (tradenames, manufactured by Mitsubishi Oil Co., Ltd.); MOBILZOL K 22, 30 and 130 (tradenames, manufactured by Mobil Oil Co., Ltd.); and PETOLEX LPO-R, LPO-V, PF-1 and PF-2 (tradenames, manufactured by Yamabun Yuka Co., Ltd.).

As the softener, there may also be used di-(2-ethylhexyl)phthalate (DOP) such as DOP (tradename, manufactured by Daihachi Chemical Industry Co., Ltd., Japan) and Vinycizer 80 (tradename, manufactured by Kao Corpoartion, Japan); a higher alcohol phthalate such as Reoflex 9P (tradename, manufactured by Shell Japan Ltd.), and DIACIZER 11 and 99 (tradename, manufactured by Mitsubishi Chemical Corporation, Japan); diisooctyl phthalate (DIOP) such as DIOP (tradename, manufactured by Wacker-Chemie, Germany); di-(2-ethylhexyl)sebacate such as Sansocizer DOS (tradename, manufactured by New Japan Chemical Co., Ltd., Japan); an isooctyl ester of tall oil fatty acid such as Alizona 208 (tradename, manufactured by Alizona Chem., U.S.A.); tributyl phosphate (TBP) such as TBP (tradename, manufactured by Daihachi Chemical Industry Co., Ltd.); tributoxyethyl phosphate (TBEP) such as TBEP (tradename, manufactured by Daihachi Chemical Industry Co., Ltd.); tricresyl phosphate (TCP) such as Sansocizer TCP (tradename, manufactured by New Japan Chemical Co., Ltd.); cresyl diphenyl phosphate (CDP) such as CDP (tradename, manufactured by Daihachi Chemical Industry Co., Ltd.); diphenyl alkane such as Koremoll CE 54 22 (tradename, manufactured by BASF, Germany); and di(butoxyetoxyethyl)adipate such as Thiocol TP-95 (tradename, manufactured by Morton International Inc., U.S.A.).

In general, one or two of the softeners are appropriately used. Different types of the oils may be used in combination according to need For example, a blend of a naphthenic oil with a paraffinic oil may be used. Further, a rubber-substitute (factice) may be used in an amount of 5 to 50 parts by weight relative to 100 parts by weight of the base rubber material, taking surface abrasion properties and the like into consideration when the composition is used as a rubber layer of a recording medium feeding roller. Examples of the rubber-substitute include Brown factice, White factice, Semitransparent factice, Golden factice, Neo factice, and Sulfurless factice (tradenames, manufactured by Tenma Sub kako K.K., Japan).

In the present invention, a silica reinforcer is added in an amount of 15 to 40 parts by weight, preferably 20 to 30 parts by weight, relative to 100 parts by weight of the base rubber material. If the amount is lass than 15 parts by weight, deposition of a migratory stain is not effectively prevented. On the other hand, if the amount exceeds 40 parts by weight, a rubber composition having a low hardness is hardly obtained and roll performance of the rubber composition becomes poor.

Examples of the silica reinforcer include anhydrous silica reinforcers such as AEROSIL 130, 200, 300, 380, R972 and R974 (tradenames, manufactured by Degussa Corp., Geremany); and REOLOSIL QS13, QS30, QS38 and QS102 (tradenames, manufactured by Tokuyama Corporation, Japan); and also include hydrous silica reinforcers such as CARPLEX #67, #80, #100, #1120, XR, 22S, CS-5 and CS-7 (tradenames, manufactured by Shionogi & Co., Ltd., Japan); SILTON A and R-2 (tradenames, manufactured by Mizusawa Industrial Chemicals Co., Ltd., Japan); TOKUSIL AL-1, Gu, U, UR and US (tradenames, manufactured by Tokuyama Corporation); NIPSIL AQ, ER, LP, NA, NP, NS-K and VN3 (tradenames, manufactured by Nippon Silica Industrial Co., Ltd., Japan); Ultrasil VN3 (tradename, manufactured by Degussa Corp., Germany); and Hi-Sil 233 (tradename, manufactured by PPG Industries, U.S.A.).

Further, in combination with the silica reinforecer, there may appropriately be used a carbon black; an activated calcium carbonate such as HAKUENNKA CC, DD, O and U (tradenames, manufactured by Shiraishi Kogyo Kaisha, Ltd., Japan) a speciality calcium carbonate such as HAKUENKA and AA (tradenames, manufactured by Shiraishi Kogyo Kaisha, Ltd.); a magnesium silicate such as MISTRON VAPOR (tradename, manufactured by Nippon Mistron K. K., Japan); a clay (aluminum silicate); and a silane-coated clay such as ST-100, ST-200 and ST-301 (tradenames, manufactured by Shiraishi Calcium Kaisha, Ltd., Japan), NULCK 321 and NUCAP 100, 190, 200 and 390 (tradenames, manufactuerd by J. M. Huber Co., U.S. A.), and BURGESS KE, CB, 5178 and 2211 (tradenames, manufactured by Burgess Pigment Co., U.S. A).

To the rubber composition for a roller according to the present invention, with a view to attaining improved dimensional stability and a low cost, an extender filler may be added in an amount of about 10 to 100 parts by weight relative to 100 parts by weight of the base rubber material.

Examples of the extender filler include a light calcium carbonate such as Green Ball (tradename, manufactured by Inoue Calcium Corporation, Japan), TAMA PEARL TP-121, TP-121R TP-222H, TP-222HS, TP-123 and TP-123CS (tradenames, manufactured by Okutama Kogyo Co., Ltd., Japan), and SILVER W (tradename, manufactured by Shiraishi Kogyo Kaisha, Ltd.); a heavy calcium carbonate such as WHITERON SSB, SB and S (tradenames, manufactured by Shiraishi Calcium Kaisha, Ltd.), SUNLIGHT #100, #300, #700, #8 00, #1000, #1500, #2000, #2200 and #2500 (tradenames, manufactured by Takehara Chemical Industrial Co., Ltd., Japan), NS#100, NS#200, NS#400, NS#600, NS#1000, NS#2300, NS#2500, NS#2700, NS#3000, SS#30, SS#80, NN#200 and NN#500 (tradenames, manufactured by Nitto Funka Kogyo K.K., Japan), and SUPER S, SS, SSS, 4S, #1500, #1700 and #2000 (tradenames, manufactured by Maruo Calcium Co., Ltd., Japan); a Talc such as JET-S (tradename, manufactured by Asada Milling Co., Ltd., Japan), TALC GTA, CTA1, CTA2 and Fine Powder Talc (tradenames, manufactured by Kunimine Industries Co., Ltd., Japan), and MS, MS-P, MS-A, ND, SW, SW-E, SWA, SWB, SSS, SS and S (tradenames, manufactured by Nippon Talc Co., Ltd., Japan); a ground quartz such as CRYSTLITE AA, VX-S, VX-S-2 and VX-SR (tradenames, manufactured by Tatsumori Ltd., Japan), MIN-U-SIL 5, 10, 15, and 30 (tradenames, manufactured by U.S. Silica, U.S.A), and IMSILA-10, A-15, A-25 and A-108 (tradenames, manufactured by Illinois Minerals, U.S.A.) a wollastnite (calcium metasilicate) such as JA-30W and 325M (tradenames, manufactured by Asada Milling Co., Ltd.), and NYAD 325, 400, 1250 and G (tradenames, manufactured by NYCO, U.S.A.); a diatomaceous earth such as CELITE 270, 281, 501, 503, 505, 535, 545, 560 577, FC and SSC, SUPER FLOSS and SNOW FLOSS (tradenames, manufactured by Johns-Manville, U.S.A); zinc oxide; aluminum sulfate; barium sulfate; calcium sulfate; titanium dioxide; and molybdenum disulfide. In general, one to several extender fillers are used in combination with the reinforcer.

To the rubber composition for a roller according to the present invention, a lubiricant or internal parting agent may be added according to need in an amount of about 0.3 to 5 parts by weight relative to 100 parts by weight of the base rubber material, with a view to improving roll performance and extrusion properties. However, addition of the lubricant or internal parting agent in too large an amount tends to cause blooming, bleeding, joint and the like. Accordingly, the lubricant or internal parting agent is generally added in an amount of about 0.5 to 1 part by weight, although the amount depends upon kinds of the lubricant or internal parting agent.

Examples of the lubricant or internal parting agent include a polyethylene wax such as MITSUI HI-WAX 100P, 110P, 200P, 210P, 22 0P, 320P and 420P (tradenames, manufactured by Mitsui Petrochemical Industries, Ltd., Japan); a stearic acid such as LUNAC S-20, S-30 and S-40 (tradenames, manufactured by Kao Co., Ltd.) FA-KR (tradename, manufactured by Nippon Oil & Fats Co., Ltd.), and ADEKA FATTY ACID SA-20, SA-300 and SA-400 (tradenames, manufactured by Asahi Denka Kogyo K.K., Japan); a fatty acid amid such as PLASTRODINE and PLASTRODINE S (tradenames, manufactured by Fujisawa Pharmaceutical Co., Ltd., Japan); a nitrogen delivative of a fatty acid such as Armowax EBS (tradename, manufactured by Lion Akzo Co., Ltd.); a poler compound/surfactant blend such as Aflex 42 (tradename, manufactured by Rein Chemie, Germany); a salt of an unsaturated higher fatty acid with zinc such as Struktol A60 (tradename, manufactured by Schill & Seillacher, Germany); a special zinc fatty acid such as Struktol EF44 (tradename, manufactured by Schill & Seillacher, Germany); a fatty acid calcium/fatty acid amide blend such as Struktol WB16 (tradename, manufactured by Schill & Seillacher, Germany); a blend of fatty acid ester/fatty acid metallic salt such as Struktol WB42 (tradename, manufactured by Schill & Seillacher, Germany); a blend of hydrated higher fatty acid ester/inorganic carrier such as Struktol WB212 (tradename, manufactured by Schill & Seillacher, Germany); a polyhydric alcohol/fatty acid ester such as Struktol WB 222 (tradename, manufactured by Schill & Seillacher, Germany); a condensation product of organic silicone such as Struktol WS180 (tradename, manufactured by Schill & Seillacher, Germany); a blend of high molecular weight natural aliphatic alcohol/aliphatic soap, which is treated into an inert filer, such as Struktol W33FL (tradename, manufactured by Schill & Seillacher, Germany); a paraffin wax; and a montan wax.

In the following, specific examples of the roller according to the present invention will be described. It is, however, to be understood that the present invention is by no means restricted to the specific examples.

### EXAMPLE 1

200 parts by weight of Esprene 600F (tradename, manufactured by Sumitomo Chemical Co., Ltd.), which comprises 100 parts by weight of an ethylene/propylene-copolimerized rubber as a base rubber material extended with 100 parts by weight of a naphthenic oil, 25 parts by weight of Diana Process Oil PW90 (tradename, manufactured by Idemitsu Kosan Co., Ltd.) as a softener, 20 parts by weight of Nipseal VN3 (manufactured by Nippon Silica Industrial Co., Ltd.) as a silica reinforcer, 5 parts by weight of Zinc Oxide No. 1 (tradename, manufactured by Sakai Chemical Industry Co., Ltd.), 1 part by weight of Lunac S-20 (tradename, manufactured by Kao Corp.) as stearic acid, 0.3 part by weight of Seast 3 (tradename of a carbon black, manufactured by Tokai Carbon K.K.) as a colorant, 0.5 part by weight of “Golden Flower” sulfur powder (tradename, manufactured by Tsurumi Chemical Industry, Co., Ltd.) of 325 mesh as a cure agent (vulcanizing agent), and 1.5 parts by weight of Accel TS (tradename, manufactured by Kawaguchi Chemical Industry Co., Ltd.) and 0.5 part by weight of Accel M (tradename, manufactured by Kawaguchi Chemical Industry Co., Ltd.) as vulcanization accelerators are weighed out and mixed together and then kneaded by means of well-known rubber kneader rolls to prepare an unvulcanized rubber composition for a roller. The rubber composition has such a formulation that the total amount of the softener is 125 parts by weight and the amount of the silica reinforcer is 20 parts by weight.

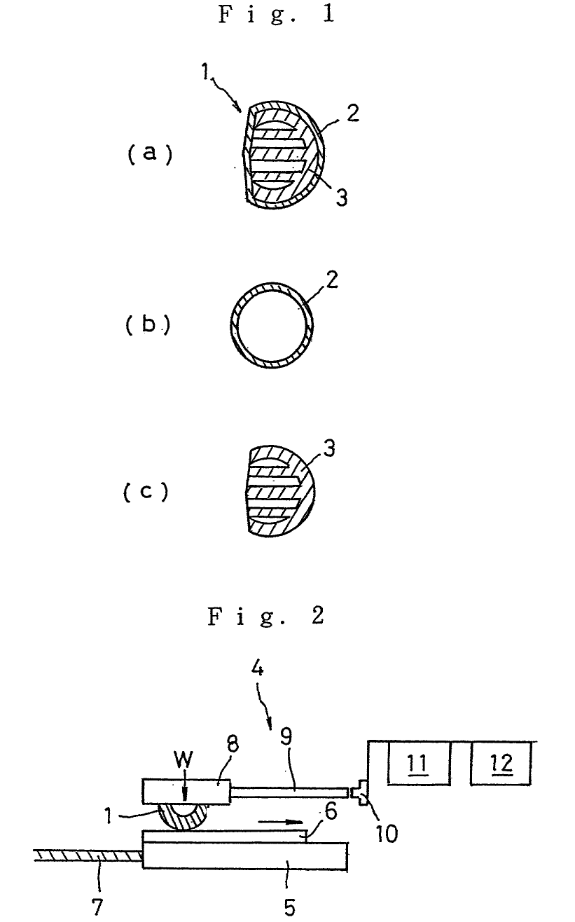

A recording medium feeding roller 1 as shown in FIG. 1(a) is fabricated which uses the rubber composition for a roller of this example, and for evaluation of physical properties in accordance with ASTM D 3182, test pieces made of the rubber composition for a roller of this example is prepared. The recording medium feeding roller 1 is referred to as a paper feed roller, separators roller, pickup roller or the like and prepared by vulcanization-molding the unvulcanized rubber composition by means of a mold having a predetermined shape to form a substantially cylindrical rubber ring 2 (outer diameter: 22.5 mm thickness: 1.5 mm rubber width: 15 mm) as shown in FIG. 1(b), and circumferencially fitting the rubber ring 2 over a holder 3 as shown in FIG. 1(c).

### EXAMPLE 2

An unvulcanized rubber composition is prepared in substantially the same manner as in Example 1 except that the amount of the Diana Process Oil PW90 as a softener is changed from 25 parts by weight to 30 parts by weight. The rubber composition has such a formulation that the total amount of the softener is 130 parts by weight and the amount of the silica reinforcer is 20 parts by weight.

A recording medium feeding roller using the rubber composition for a roller of this example, and test pieces made of the rubber composition for a roller of this example are prepared in substantially the same manner as in Example 1.

### EXAMPLE 3

An unvulcanized rubber composition is prepared in substantially the same manner as in Example 1 except that the amount of the Diana Process Oil PW90 as a softener is changed from 25 parts by weight to 40 parts by weight. The rubber composition has such a formulation that the total amount of the softener is 140 parts by weight and the amount of the silica reinforcer is 20 parts by weight.

A recording medium feeding roller using the rubber composition for a roller of this example, and test pieces made of the rubber composition for a roller of this example are prepared in substantially the same manner as in Example 1.

### EXAMPLE 4

An unvulcanized rubber composition is prepared in substantially the same manner as in Example 1 except that the amount of the Diana Process Oil PW90 as a softener is changed from 25 parts by weight to 50 parts by weight and the amount of Nipseal VN3 as a silica reinforcer is changed from 20 parts by weight to 25 parts by weight. The rubber composition has such a formulation that the total amount of the softener is 150 parts by weight and the amount of the silica reinforcer is 25 parts by weight.

A recording medium feeding roller using the rubber composition for a roller of this example, and test pieces made of the rubber composition for a roller of this example are prepared in substantially the same manner as in Example 1.

### EXAMPLE 5

An unvulcanized rubber composition is prepared in substantially the same manner as in Example 1 except that the amount of the Diana Process Oil PW90 as a softener is changed from 25 parts by weight to 60 parts by weight and the amount of Nipseal VN3 as a silica reinforcer is changed from 20 parts by weight to 30 parts by weight The rubber composition has such a formulation that the total amount of the softener is 160 parts by weight and the amount of the silica reinforcer is 30 parts by weight.

A recording medium feeding roller using the rubber composition for a roller of this example, and test pieces made of the rubber composition for a roller of this example are prepared in substantially the same manner as in Example 1.

### EXAMPLE 6

An unvulcanized rubber composition is prepared in substantially the same manner as in Example 1 except that the amount of the Diana Process Oil PW90 as a softener is changed from 25 parts by weight to 80 parts by weight and the amount of Nipseal VN3 as a silica reinforcer is changed from 20 parts by weight to 40 parts by weight. The rubber composition has such a formulation that the total amount of the softener is 180 parts by weight and the amount of the silica reinforcer is 40 parts by weight.

A recording medium feeding roller using the rubber composition for a roller of this example, and test pieces made of the rubber composition for a roller of this example are prepared in substantially the same manner as in Example 1.

### EXAMPLE 7

An unvulcanized rubber composition is prepared in substantially the same manner as in Example 1 except that the amount of the Diana Process Oil PW90 as a softener is changed from 25 parts by weight to 30 parts by weight and the amount of Nipseal VN3 as a silica reinforcer is changed from 20 parts by weight to 15 parts by weight. The rubber composition has such a formulation that the total amount of the softener is 130 parts by weight and the amount of the silica reinforcer is 15 parts by weight.

A recording medium feeding roller using the rubber composition for a roller of this example, and test pieces made of the rubber composition for a roller of this example are prepared in substantially the same manner as in Example 1.

### EXAMPLE 8

An unvulcanized rubber composition is prepared in substantially the same manner as in Example 1 except that the amount of the Diana Process Oil PW90 as a softener is changed from 25 parts by weight to 80 parts by weight and the amount of Nipseal VN3 as a silica reinforcer is changed from 20 parts by weight to 15 parts by weight. The rubber composition has such a formulation that the total amount of the softener is 180 parts by weight and the amount of the silica reinforcer is 15 parts by weight.

A recording medium feeding roller using the rubber composition for a roller of this example, and test pieces made of the rubber composition for a roller of this example are prepared in substantially the same manner as in Example 1.

### COMPARATIVE EXAMPLE 1

An unvulcanized rubber composition is prepared in substantially the same manner as in Example 1 except that the amount of the Diana Process Oil PW90 as a softener is changed from 25 parts by weight to 0 part by weight and the amount of Nipseal VN3 as a silica reinforcer is changed from 20 parts by weight to 0 part by weight. The rubber composition has such a formulation that the total amount of the softener is 100 parts by weight and no silica reinforcer is contained.

A recording medium feeding roller using the rubber composition for a roller of this comparative example, and test pieces made of the rubber composition for a roller of this comparative example are prepared in substantially the same manner as in Example 1.

### COMPARATIVE EXAMPLE 2

An unvulcanized rubber composition is prepared in substantially the same manner as in Example 1 except that the amount of the Diana Process Oil PW90 as a softener is changed from 25 parts by weight to 0 part by weight and the amount of Nipseal VN3 as a silica reinforcer is changed from 20 parts by weight to 10 parts by weight. The rubber composition has such a formulation that the total amount of the softener is 100 parts by weight and the silica reinforcer is contained in an amount of 10 parts by weight.

A recording medium feeding roller using the rubber composition for a roller of this comparative example, and test pieces made of the rubber composition for a roller of this comparative example are prepared in substantially the same manner as in Example 1.

### COMPARATIVE EXAMPLE 3

An unvulcanized rubber composition is prepared in substantially the same manner as in Example 1 except that the amount of the Diana Process Oil PW90 as a softener is changed from 25 parts by weight to 0 part by weight and the amount of Nipseal VN3 as a silica reinforcer is changed from 20 parts by weight to 15 parts by weight The rubber composition has such a formulation that the total amount of the softener is 100 parts by weight and the silica reinforcer is contained in an amount of 15 parts by weight.

A recording medium feeding roller using the rubber composition for a roller of this comparative example, and test pieces made of the rubber composition for a roller of this comparative example are prepared in substantially the same manner as in Example 1.

### COMPARATIVE EXAMPLE 4

An unvulcanized rubber composition is prepared in substantially the same manner as in Example 1 except that the amount of the Diana Process Oil PW90 as a softener is changed from 25 parts by weight to 0 part by weight. The rubber composition has such a formulation that the total amount of the softener is 100 parts by weight and the silica reinforcer is contained in an amount of 20 parts by weight.

A recording medium feeding roller using the rubber composition for a roller of this comparative example, and test pieces made of the rubber composition for a roller of this comparative example are prepared in substantially the same manner as in Example 1.

### COMPARATIVE EXAMPLE 5

An unvulcanized rubber composition is prepared in substantially the same manner as in Example 1 except that the amount of the Diana Process Oil PW90 as a softener is changed from 25 parts by weight to 0 part by weight and the amount of Nipseal VN3 as a silica reinforcer is changed from 20 parts by weight to 25 part by weight. The rubber composition has such a formulation that the total amount of the softener is 100 parts by weight and the silica reinforcer is contained in an amount of 25 parts by weight.

A recording medium feeding roller using the rubber composition for a roller of this comparative example, and test pieces made of the rubber composition for a roller of this comparative example are prepared in substantially the same manner as in Example 1.

### COMPARATIVE EXAMPLE 6

An unvulcanized rubber composition is prepared in substantially the same manner as in Example 1 except that the amount of the Diana Process Oil PW90 as a softener is changed from 25 parts by weight to 20 parts by weight and the amount of Nipseal VN3 as a silica reinforcer is changed from 20 parts by weight to 0 part by weight. The rubber composition has such a formulation that the total amount of the softener is 120 parts by weight and no silica reinforcer is contained.

A recording medium feeding roller using the rubber composition for a roller of this comparative example, and test pieces made of the rubber composition for a roller of this comparative example are prepared in substantially the same manner as in Example 1.

### COMPARATIVE EXAMPLE 7

An unvulcanized rubber composition is prepared in substantially the same manner as in Example 1 except that the amount of the Diana Process Oil PW90 as a softener is changed from 25 parts by weight to 20 parts by weight and the amount of Nipseal VN3 as a silica reinforcer is changed from 20 parts by weight to 10 parts by weight. The rubber composition has such a formulation that the total amount of the softener is 120 parts by weight and the silica reinforcer is contained in an amount of 10 parts by weight.

A recording medium feeding roller using the rubber composition for a roller of this comparative example, and test piece made of the rubber composition for a roller of this comparative example are prepared in substantially the same manner as in Example 1.

### COMPARATIVE EXAMPLE 8

An unvulcanized rubber composition is prepared in substantially the same manner as in Example 1 except that the amount of the Diana Process Oil PW90 as a softener is changed from 25 parts by weight to 20 parts by weight. The rubber composition has such a formulation that the total amount of the softener is 120 parts by weight and the silica reinforcer is contained in an amount of 20 parts by weight.

A recording medium feeding roller using the rubber composition for a roller of this comparative example, and test piece made of the rubber composition for a roller of this comparative example are prepared in substantially the same manner as in Example 1.

Next, performance tests on the rubber compositions for a roller in Examples 1 to 8 and Comparative Examples 1 to 8 are performed The performance tests include tests on ordinary state physical properties and measurements of specific gravities, which use the test pieces, and measurements of coefficients of dynamic friction and evaluations of migration and evaluations of feeding properties, which use the recording medium feeding rollers as shown in FIG. 1. The tests on ordinary state physical properties of the test pieces, the measurements of specific gravities of the test pieces, and the measurements of coefficients of dynemic friction are carried out in accordance with ASTMD 412 and ASM D 2240, ASTM D 297, and ASTM D 1894 e, respectively.

The measurement of coefficient of dynamic friction will be described with reference to FIG. 2.

FIG. 2 is an illustrative view schematically showing a friction coefficient measuring system.

As shown in FIG. 2, a friction coefficient measuring system 4 for determining a coefficient of dynamic friction in accordance with ASTM D 1894 e has a plate-like recording medium bed 5 for placing sheets of predetermined recording medium 6 thereon. A threaded rod 7 rotationally driven by a driving motor (not shown) is screwed into the recording medium bed 5. The recording medium bed 5 is thereby movable to-and-fro in the axial directrion of the threaded rod 7 by the rotational force of the driving motor. Above the recording medium bed 5, a mounting member 8 is located on which a recording medium feeding roller 1 as shown in FIG. 1 is unrotatably mounted. To the right side (as seen in FIG. 2) of the mounting member 8, a measuring rod 9 is fixedly attached at its proximal end in such a manner that it extends above and in parallel with the recording medium bed 5. In front of the measuring rod 9, a distortion gauge 10 is positioned oppositely to the distal end (free end) of the measuring rod 9. To the distortion gauge 10, an amplifier 11 and a recorder 12 are electrically connected.

In the friction coefficient measuring system 4 constructed as described above, sheets of predetermined recording medium 6 are placed on the upper surface of the recording medium bed 5. The recording medium feeding roller 1 is first placed on the sheets of recording medium 6 in such a manner that no substantial load is applied onto the sheets, and then predetermined normal load W is applied thereto. The recording medium feeding roller 1 is thereby caused to abut on the sheets of recording medium 6 with normal load W. Then, the driving motor is actuated to move the bed 5 in the rihgt direction shown by arrow in FIG. 2. This in tern moves the recording medium feeding roller 1 abutting on the bed 5 via the sheets of recording medium 6 in the right direction, and the mounting member 8 and the measuring rod 9 as well. The movement of the roller 1, the mounting member 8 and the measuring rod 9 in the right direction is terminated when the distal end of the measuring rod 9 abuts on the distortion gauge 10. However, the movement of the bed 5 and the sheets of recording medium 6 is not discontinued. As a result, frictional force F of the recording medium feeding roller 1 on the recording medium 6 is detected by the distortion gauge 10. The detected frictional force F is amplified by the amplifier 11 and recorded by the recorder 12. The frictional force F is low when the recording medium feeding roller 1 has a low coefficient of dynamic friction and thus has tendency to slide, and it (F) is high when the roller 1 has a high coefficient of dynamic friction and high tackiness. Accordingly, a coefficient of dynamic friction μ is derived from the normal load W and the frictional force F and represented by the formula: μ=F/W, thereby enabling determination of the coefficient of dynamic friction μ.

In the evaluation of migration, the recording medium feeding roller 1 is incorporated into a BJC-410J printer (tradename, manufactured by Canon Inc., Japan), and the roller is caused to abut upon a sheet of OHP paper as recording medium 6 and allowed to stand at room temperature in a dark place for seven days. The OHP paper sheet is then examined with naked eyes whether or not migratory stain is deposited on the surface thereof from the recording medium feeding roller 1. The evaluation is made according to the three-rank criterion, i.e., no migration (◯: no deposition of migratory stain is observed), slight migration (Δ: deposition of migratory stain is slightly observed but no substantial practical problem is caused), and migration (X: deposition of migratory stain is apparently observed).

In the evaluation of transfer properties, the recording medium feeding roller 1 is incorporated into a BJC-410J printer (tradename, manufactured by Canon Inc.), and 100 sheets of PPC paper as recording medium 6 are consecutively transferred. It is visually observed whether multi-sheets transfer or transfer failure is caused or not. The evaluation is made according to the two-rank criterion, i.e., good transfer properties (◯: no multi-sheet transfer or transfer failure is observed), and poor transfer properties (X: multi-sheet transfer or transfer failure is caused).

The formulations of the rubber compositions in Examples and Comparative Examples, and the results of the evaluations are shown in Tables 1 and 2.

TABLE 1

| | formula (phr) | | | | | | | |
|---|---|---|---|---|---|---|---|---|
| | E1 | E2 | E3 | E4 | E5 | E6 | E7 | E8 |
| ingredients | | | | | | | | |
| Esprene 600F | 200 | 200 | 200 | 200 | 200 | 200 | 200 | 200 |
| Diana Process Oil PW90 | 25 | 30 | 40 | 50 | 60 | 80 | 30 | 80 |
| Nipseal VN3 | 20 | 20 | 20 | 25 | 30 | 40 | 15 | 15 |
| Zinc Oxide No. 1 | 5 | 5 | 5 | 5 | 5 | 5 | 5 | 5 |
| stearic acid | 1 | 1 | 1 | 1 | 1 | 1 | 1 | 1 |
| Seast 3 (MAF carbon) | 0.3 | 0.3 | 0.3 | 0.3 | 0.3 | 0.3 | 0.3 | 0.3 |
| Accel TS | 1.5 | 1.5 | 1.5 | 1.5 | 1.5 | 1.5 | 1.5 | 1.5 |
| Accel M | 0.5 | 0.5 | 0.5 | 0.5 | 0.5 | 0.5 | 0.5 | 0.5 |
| Golden Flower sulfer powder | 1.5 | 1.5 | 1.5 | 1.5 | 1.5 | 1.5 | 1.5 | 1.5 |
| (325 mesh) | | | | | | | | |
| total | 254.8 | 259.8 | 269.8 | 284.8 | 299.8 | 329.8 | 254.8 | 304.8 |
| results of evaluation | | | | | | | | |
| hardness ‡ (JIS A) | 29 | 28 | 25 | 28 | 30 | 30 | 27 | 24 |
| tensile strength ‡ (MPa) | 7.5 | 6.9 | 8.5 | 9.7 | 12.2 | 14.6 | 8.2 | 7.1 |
| elongation ‡ (%) | 700 | 690 | 720 | 650 | 630 | 670 | 650 | 630 |
| specific gravity ‡ | 0.94 | 0.94 | 0.93 | 0.94 | 0.94 | 0.95 | 0.93 | 0.91 |
| dynamic friction coefficient | 2.2 | 2.2 | 2.3 | 2.2 | 2.1 | 2.2 | 2.2 | 2.4 |
| migration | ◯ | ◯ | ◯ | ◯ | ◯ | ◯ | Δ | Δ |
| transfer properties | ◯ | ◯ | ◯ | ◯ | ◯ | ◯ | ◯ | ◯ |

‡ physical properties

TABLE 2

| | formula (phr) | | | | | | | |
|---|---|---|---|---|---|---|---|---|
| | C1 | C2 | C3 | C4 | C5 | C6 | C7 | C8 |
| ingredients | | | | | | | | |
| Esprene 600F | 200 | 200 | 200 | 200 | 200 | 200 | 200 | 200 |
| Diana Process Oil PW90 | 0 | 0 | 0 | 0 | 0 | 20 | 20 | 20 |
| Nipseal VN3 | 0 | 10 | 15 | 20 | 25 | 0 | 10 | 20 |
| Zinc Oxide No. 1 | 5 | 5 | 5 | 5 | 5 | 5 | 5 | 5 |
| stearic acid | 1 | 1 | 1 | 1 | 1 | 1 | 1 | 1 |
| Seast 3 (MAP carbon) | 0.3 | 0.3 | 0.3 | 0.3 | 0.3 | 0.3 | 0.3 | 0.3 |
| Accel TS | 1.5 | 1.5 | 1.5 | 1.5 | 1.5 | 1.5 | 1.5 | 1.5 |
| Accel M | 0.5 | 0.5 | 0.5 | 0.5 | 0.5 | 0.5 | 0.5 | 0.5 |
| Golden Flower sulfer powder | 1.5 | 1.5 | 1.5 | 1.5 | 1.5 | 1.5 | 1.5 | 1.5 |
| (325 mesh) | | | | | | | | |
| total | 209.8 | 219.8 | 224.8 | 229.8 | 234.8 | 229.8 | 239.8 | 249.8 |
| results of evaluation | | | | | | | | |
| hardness ‡ (JIS A) | 30 | 33 | 35 | 36 | 37 | 28 | 29 | 31 |
| tensile strength ‡ (MPa) | 2.1 | 9.8 | 12.1 | 14.0 | 15.1 | 1.4 | 6.2 | 8.0 |
| elongation ‡ (%) | 450 | 620 | 730 | 850 | 800 | 380 | 600 | 750 |
| specific gravity ‡ | 0.90 | 0.93 | 0.94 | 0.95 | 0.96 | 0.90 | 0.92 | 0.94 |
| dynamic friction coefficient | 2.1 | 1.8 | 1.7 | 1.6 | 1.5 | 2.3 | 2.2 | 2.0 |
| migration | X | X | Δ | ◯ | ◯ | X | X | ◯ |
| transfer properties | ◯ | X | X | X | X | ◯ | ◯ | X |

‡ physical properties

In Tables 1 and 2, Esprene 600F is an oil-extended ethylene/propyrene/non-conjugated diene terpolymer rubber (EPDM), and 200 parts by weight of this grade contains 100 parts by weight of a naphthenic oil as a softener.

From the results of the evaluation on migration, it is found that each of the recording medium feeding rollers 1 using the rubber compositions for a roller in Examples 1 to 8 has a high coefficient of dynamic friction and is substantially free from migration and exhibits satisfactory transfer properties. It is found to be necessary for prevention of migration (for freedom from migration) that not only 125 to 180 parts by weight of a softener but also at least 15 parts by weight, preferably 20 parts by weight or more of a silica reinforcer be added to 100 parts by weight of an EPDM as a base rubber material. The reason why the freedom from migration is attained by the addition of the silica reinforcer is not clearly understood. However, the reason is believed to be attributable to adsorption of a polymerization catalyst contained in the EPDM as a base rubber material, an impurity contained in the extender oil and so forth on the silica.

On the other hand, with respect to Comparative Examples 1 to 8 wherein the rubber compositions each has a softener content less than 125 parts by weight, it is found that the recording medium feeding rollers 1 using the rubber compositions for a roller cannot provide adequate transfer properties except those using the rubber compositions in Comparative Examples 1, 6 and 7. However, the recording medium feeding rollers 1 using the rubber compositions in Comparative Examples 1, 6 and 7 are found to be inadequate as a recording medium feeding roller, because undesirably considerable migrations onto recording medium are caused although each of them has a low hardness and thus has a low coefficient of dynamic friction and exhibits good transfer properties.

By virtue of the use of the rubber composition of the present invention to fabricate a recording medium feeding roller 1, which contains 125 to 180 parts by weight of a softener and 15 to 4 0 parts by weight of a silica reinforcer relative to 100 parts by weight of an EPDM, the recording medium transfer roller has a high coefficient of dynamic friction and satisfactory transfer properties and is capable of surely preventing migratory stain from depositing onto the surface of recording medium 6 when brought into contact with the recording medium 6.

What is claimed is:

1. A rubber composition for a roller, said rubber composition comprising:
100 parts by weight of an ethylene/propylene/non-conjugated diene terpolymer,
125 to 180 parts by weight of a softener, and
15 to 40 parts by weight of a silica reinforcer.

2. The rubber composition for a roller according to claim 1, wherein said silica reinforcer is a hydrous silica or anhydrous silica.

3. A recording medium feeding roller, at least whose surface is made of the rubber composition for a roller according to claim 1 or 2.
